(19) United States
(12) Patent Application Publication
(10) Pub. No.: US 2025/0038616 A1
(43) Pub. Date: Jan. 30, 2025

(54) HOUSING AND ROTATING ELECTRIC MACHINE

(71) Applicant: HONDA MOTOR CO., LTD., Tokyo (JP)

(72) Inventors: Keiji Tada, Wako-shi (JP); Yuji Ono, Wako-shi (JP); Hiroshi Nagami, Wako-shi (JP); Masaki Sato, Wako-shi (JP); Yoshiyuki Hoshi, Wako-shi (JP)

(21) Appl. No.: 18/784,384

(22) Filed: Jul. 25, 2024

(30) Foreign Application Priority Data
Jul. 28, 2023 (JP) 2023-123430

(51) Int. Cl. H02K 5/20; H02K 9/19

(52) U.S. Cl. CPC H02K 5/203; H02K 9/19

(57) ABSTRACT

A housing includes an inner tube component having a tubular shape and capable of accommodating therein a heating element, a cooler having a tubular shape and defining a coolant passage for causing a coolant to flow along an outer peripheral surface of the inner tube component, and an outer tube component having a tubular shape and accommodating therein the inner tube component and the cooler.

### CROSS-REFERENCE TO RELATED APPLICATIONS

This application is based upon and claims the benefit of priority from Japanese Patent Application No. 2023-123430 filed on Jul. 28, 2023, the contents of which are incorporated herein by reference.

### BACKGROUND OF THE INVENTION

### Field of the Invention

The present invention relates to a housing and a rotating electric machine.

### Description of the Related Art

JP 2022-157733 A discloses a rotating electric machine system connected to a gas turbine engine. The rotating electric machine system includes a rotor, a stator, and a housing. The rotor and the stator are accommodated in the housing. The housing has a substantially cylindrical shape with a thick side wall extending along the left-right direction. A cooling jacket through which a cooling medium flows is formed inside the side wall.

### SUMMARY OF THE INVENTION

There has been a demand for a housing and a rotating electric machine which are more favorable.

An object of the present invention is to solve the above-mentioned problem.

A housing of a first aspect of the present invention comprises: an inner tube component having a tubular shape and configured to accommodate a heating element in an interior of the inner tube component; a cooler having a tubular shape and configured to define a coolant passage for causing a coolant to flow along an outer peripheral surface of the inner tube component; and an outer tube component having a tubular shape and configured to accommodate the inner tube component and the cooler in an interior of the outer tube component.

A rotating electric machine of a second aspect of the present invention comprises the housing according to the first aspect.

According to the present invention, it is possible to provide a housing and a rotating electric machine which are more favorable.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic view of a rotating electric machine;

FIG. 2 is a cross-sectional view of a housing;

FIG. 3 is a partial cross-sectional view of an outer tube component and a cooler;

FIG. 4 is a perspective view of an inner tube component and the cooler;

FIG. 5 is a perspective view of the inner tube component, the cooler, and the outer tube component;

FIG. 6 is a schematic view of the inside of the cooler of a first example;

FIG. 7 is a schematic view of the inside of the cooler of the first example;

FIG. 8 is a schematic view of the inside of the cooler of the first example;

FIG. 9 is a diagram showing the flow of a coolant in the first example;

FIG. 10 is an enlarged view of a pair of ribs (a rib in a first posture and a rib in a second posture);

FIG. 11 is a schematic view of the inside of the cooler of a second example;

FIG. 12 is a schematic view of the inside of the cooler of the second example;

FIG. 13 is a diagram showing the flow of the coolant in the second example; and

FIG. 14 is an enlarged view of a pair of ribs (a rib in a third posture and a rib in a fourth posture).

### DETAILED DESCRIPTION OF THE INVENTION

### [1. Rotating Electric Machine 10]

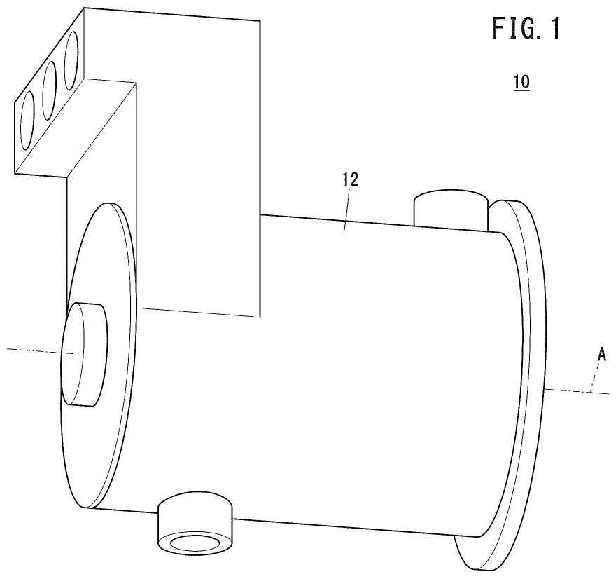

FIG. 1 is a schematic view of a rotating electric machine 10. Examples of the rotating electric machine 10 include an electric motor, a generator, or the like. The rotating electric machine 10 includes a rotor and a stator (electric device), which are not shown, and a housing 12. At least one of the rotor or the stator includes coils and an iron core. The coils and the iron core generate heat in accordance with the operation of the rotating electric machine 10. That is, the rotor and the stator are heating elements. The housing 12 accommodates the rotor and the stator inside the housing 12. The housing 12 has a function of cooling the rotor and the stator.

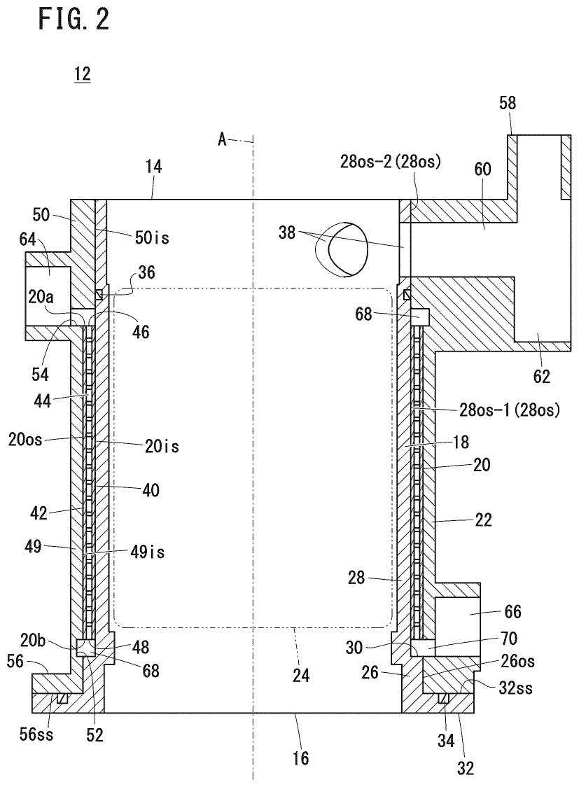

The housing 12 includes a tubular side wall. A coolant passage 44 (FIG. 2) through which a coolant flows is formed inside the side wall. The coolant passage 44 constitutes a part of a circulation passage (not shown) for circulating the coolant inside and outside the housing 12. For example, a radiator (not shown) is provided in the circulation passage outside the housing 12. In the coolant passage 44, the coolant absorbs heat generated in the rotor and the stator, and in the radiator, the coolant dissipates the heat absorbed in the coolant passage 44.

The rotating electric machine 10 is mounted on various machines. For example, the rotating electric machine 10 mounted on a moving object such as an aircraft is required to have a high output (power or electric power) and a small size (light weight). The temperature of the high-output and small-sized rotating electric machine 10 becomes higher. Therefore, the housing 12 in which the coolant passage 44 is formed needs to have a high cooling capacity. On the other hand, the housing 12 needs to have strength against external force.

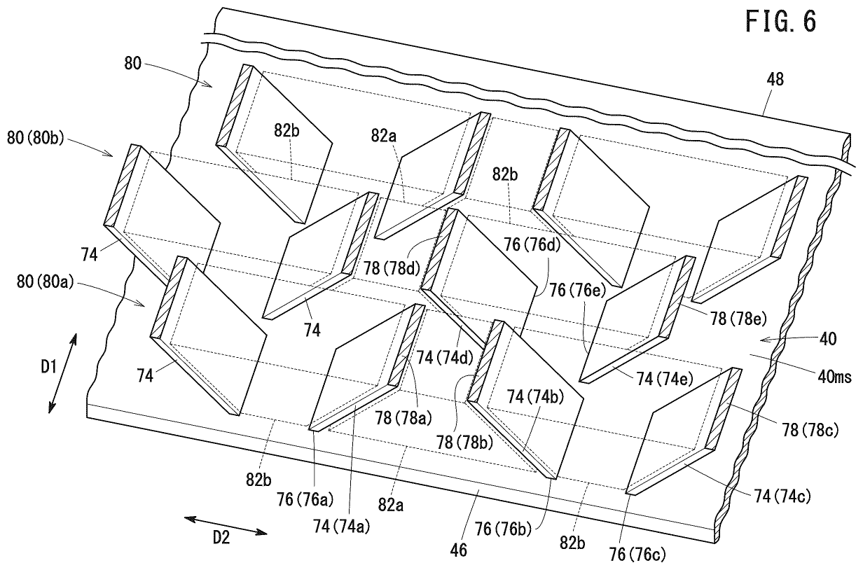

It is known that a high cooling capacity can be obtained by arranging a plurality of ribs 74 (FIG. 6 or the like) inside the coolant passage 44. As one method for further improving the cooling capacity, it is considered to make the ribs 74 finer. This can increase the surface area of the inside of the coolant passage 44. Further, since the coolant is stirred when the flow of the coolant becomes complicated, unevenness of the temperature of the coolant can be reduced. Generally, the housing 12 is manufactured by casting, forging, or the like. However, it is difficult for the fine ribs 74 to be formed inside the coolant passage 44 of the housing 12 by casting or forging.

In recent years, it has become possible to manufacture metal components using additive manufacturing in which metal is laminated while repeatedly melting and solidifying a metal powder. In the present specification, a method for manufacturing a metal component using additive manufacturing is referred to as an AM method. According to the AM method, it is possible to manufacture the fine ribs 74. However, the metal component including a fine portion may be relatively inferior in strength to a metal component not including a fine portion. In particular, when an external force acts on the fine ribs 74, the ribs 74 may be damaged.

As will be described later, in the housing 12 according to the present disclosure, a portion in which strength is required and a portion which is required to be fine are formed of separate components. As a result, it is possible for the housing 12 to have both high cooling capacity and high strength.

### [2. Structure of Housing 12]

FIG. 2 is a cross-sectional view of the housing 12. In the present specification, one end of the housing 12 in the axial direction is referred to as a first housing end portion 14, and the other end of the housing 12 in the axial direction is referred to as a second housing end portion 16. An opening is formed in each of the first housing end portion 14 and the second housing end portion 16. Each of the openings is closed by another member (not shown).

As shown in FIG. 2, the housing 12 includes an inner tube component 18, a cooler 20, and an outer tube component 22. Each of the inner tube component 18, the cooler 20, and the outer tube component 22 has a tubular shape (for example, a cylindrical shape). Axes A of the inner tube component 18, the cooler 20, and the outer tube component 22 coincide with each other. That is, the inner tube component 18, the cooler 20, and the outer tube component 22 are concentric. A part of the side wall of the housing 12 has a three layer structure in which the side walls of the inner tube component 18, the cooler 20, and the outer tube component 22 are stacked in the radial direction.

### [2-1. Inner Tube Component 18]

The inner tube component 18 is disposed closest to the axis A among the three tubular components forming the housing 12. The inner tube component 18 is a metal product formed by, for example, forging. The inner tube component 18 can accommodate the rotor and the stator in a space (an accommodation portion 24) inside the tube.

The inner tube component 18 includes a large-diameter tube portion 26 and a small-diameter tube portion 28. The large-diameter tube portion 26 is located relatively closer to the second housing end portion 16. The small-diameter tube portion 28 is located relatively closer to the first housing end portion 14. The outer diameter of an outer peripheral surface 26os of the large-diameter tube portion 26 is relatively large. The outer diameter of an outer peripheral surface 28os of the small-diameter tube portion 28 is relatively small. An annular stepped surface 30 is present between the outer peripheral surface 26os of the large-diameter tube portion 26 and the outer peripheral surface 28os of the small-diameter tube portion 28. The stepped surface 30 extends in the radial direction of the small-diameter tube portion 28 from the outer peripheral surface 28os of the small-diameter tube portion 28 to the outer peripheral surface 26os of the large-diameter tube portion 26.

An inner tube flange 32 is formed on the large-diameter tube portion 26. The inner tube flange 32 extends from the large-diameter tube portion 26 in the radial direction of the large-diameter tube portion 26. The inner tube flange 32 includes an inner tube sealing surface 32ss. An O-ring 34 is mounted on the inner tube sealing surface 32ss with the axis A as the center.

The outer peripheral surface 28os of the small-diameter tube portion 28 includes a partial outer peripheral surface 28os-1 (first partial outer peripheral surface) and a partial outer peripheral surface 28os-2 (second partial outer peripheral surface). The partial outer peripheral surface 28os-1 is disposed closer to the second housing end portion 16. The partial outer peripheral surface 28os-2 is disposed closer to the first housing end portion 14. An O-ring 36 is mounted on the partial outer peripheral surface 28os-2 with the axis A as the center.

A plurality of harness insertion holes 38 are formed in the small-diameter tube portion 28. The harness insertion holes 38 are disposed closer to the first housing end portion 14. The harness insertion holes 38 penetrate the small-diameter tube portion 28 in the radial direction. The plurality of harness insertion holes 38 are formed at the position of the partial outer peripheral surface 28os-2, and arranged along the circumferential direction of the small-diameter tube portion 28. Harnesses (not shown) are inserted into the harness insertion holes 38. The harnesses connect coils wound around the rotor or the stator accommodated in the accommodation portion 24 of the inner tube component 18 and terminals of the rotating electric machine 10 accommodated in a casing 58 of the outer tube component 22.

### [2-2. Cooler 20]

The cooler 20 is disposed outside the inner tube component 18. The cooler 20 surrounds the partial outer peripheral surface 28os-1 of the inner tube component 18. The cooler 20 is a metal product formed by, for example, the AM method.

The cooler 20 includes an inner peripheral tube portion 40 having a tubular shape, and an outer peripheral tube portion 42 having a tubular shape. The inner peripheral tube portion 40 is disposed closer to the axis A than the outer peripheral tube portion 42 is. The inner peripheral tube portion 40 forms an inner peripheral surface 20is of the cooler 20. The outer peripheral tube portion 42 surrounds the inner peripheral tube portion 40. The outer peripheral tube portion 42 forms an outer peripheral surface 20os of the cooler 20. The cooler 20 has a double tube structure of the inner peripheral tube portion 40 and the outer peripheral tube portion 42. The outer diameter of the cooler 20 is slightly smaller than the outer diameter of the large-diameter tube portion 26 of the inner tube component 18.

The coolant passage 44 for causing the coolant to flow along the partial outer peripheral surface 28os-1 of the inner tube component 18 is defined by the inner peripheral tube portion 40 and the outer peripheral tube portion 42. The coolant passage 44 has a cylindrical shape centered on the axis A. An inflow end 46, which is one end of the coolant passage 44, is disposed closer to the first housing end portion 14. An outflow end 48, which is the other end of the coolant passage 44, is disposed closer to the second housing end portion 16. A first end portion 20a of the cooler 20 is located at the inflow end 46. An inlet for the coolant in the coolant passage 44 is formed in the first end portion 20a of the cooler 20. A second end portion 20b of the cooler 20 is located at the outflow end 48. An outlet for the coolant in the coolant passage 44 is formed in the second end portion 20b of the cooler 20. Each of the inlet and the outlet for the coolant is an annular opening centered on the axis A.

As will be described later, the plurality of ribs 74 (FIG. 6 or the like) are disposed in the coolant passage 44 between the inner peripheral tube portion 40 and the outer peripheral tube portion 42. The inner peripheral tube portion 40, the outer peripheral tube portion 42, and the plurality of ribs 74 are integrally formed by the AM method. The internal structure of the cooler 20 will be described in detail later.

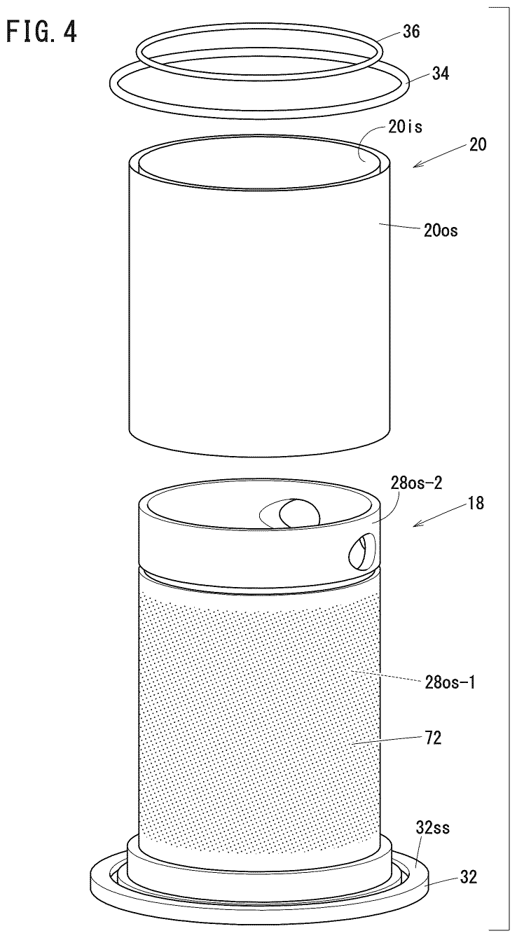

The inner peripheral surface 20is of the cooler 20 is fitted to the partial outer peripheral surface 28os-1 of the inner tube component 18. As will be described later, before the cooler 20 and the inner tube component 18 are fitted to each other, thermal grease 72 (FIG. 4) is applied to the partial outer peripheral surface 28os-1 of the inner tube component 18. Therefore, the thermal grease 72 is filled in a minute gap between the partial outer peripheral surface 28os-1 of the inner tube component 18 and the inner peripheral surface 20is of the cooler 20. By bringing the inner tube component 18 and the cooler 20 into close contact with each other without an air layer being interposed therebetween, the thermal resistance between the inner tube component 18 and the cooler 20 can be reduced. Therefore, the heat conduction performance from the inner tube component 18 to the cooler 20 can be improved.

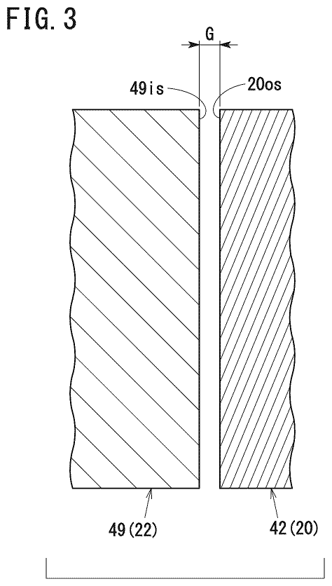

The distance from the inner peripheral surface 20is of the cooler 20 to the outer peripheral surface 20os of the cooler 20 is slightly smaller than the radial length of the stepped surface 30 of the inner tube component 18. Consequently, the outer peripheral surface 20os of the cooler 20 and an inner peripheral surface 50is of the outer tube component 22 are separated from each other. A gap G (FIG. 3) is formed between the outer peripheral surface 20os of the cooler 20 and an inner peripheral surface 49is of a large-diameter tube portion 49 of the outer tube component 22. Further, the second end portion 20b of the cooler 20 is separated from the stepped surface 30 of the inner tube component 18. As a result, a coolant discharge passage 70, which is a passage through which the coolant is discharged, can be formed inside the outer tube component 22.

### [2-3. Outer Tube Component 22]

The outer tube component 22 is disposed outside the small-diameter tube portion 28 of the inner tube component 18, outside the cooler 20, and outside the large-diameter tube portion 26 of the inner tube component 18. The outer tube component 22 surrounds the partial outer peripheral surface 28os-2 of the small-diameter tube portion 28, the outer peripheral surface 20os of the cooler 20, and the outer peripheral surface 26os of the large-diameter tube portion 26. The outer tube component 22 is a metal product formed by, for example, casting.

The outer tube component 22 includes the large-diameter tube portion 49 and a small-diameter tube portion 50. The large-diameter tube portion 49 is disposed relatively closer to the second housing end portion 16. The small-diameter tube portion 50 is disposed relatively closer to the first housing end portion 14. The inner diameter of the inner peripheral surface 49is of the large-diameter tube portion 49 is relatively large. The inner diameter of the inner peripheral surface 50is of the small-diameter tube portion 50 is relatively small. The inner diameter of the inner peripheral surface 49is of the large-diameter tube portion 49 is slightly larger than the outer diameter of the cooler 20 and is equal to the outer diameter of the large-diameter tube portion 26 of the inner tube component 18.

An annular groove 52 centered on the axis A is formed in the inner peripheral surface 49is of the large-diameter tube portion 49. An annular groove 54 centered on the axis A is formed at a boundary between the inner peripheral surface 49is of the large-diameter tube portion 49 and the inner peripheral surface 50is of the small-diameter tube portion 50.

An outer tube flange 56 is formed on the outer tube component 22. The outer tube flange 56 is disposed closer to the second housing end portion 16. The outer tube flange 56 extends from the outer tube component 22 in the radial direction of the outer tube component 22. The outer tube flange 56 includes an outer tube sealing surface 56ss. The outer tube sealing surface 56ss faces the inner tube sealing surface 32ss described above.

The casing 58 is formed in the outer tube component 22. The casing 58 is disposed closer to the first housing end portion 14. The casing 58 protrudes from the outer tube component 22 to the outside of the outer tube component 22. A harness insertion passage 60 and a terminal accommodating portion 62 are formed in the casing 58. The harness insertion passage 60 allows communication between the harness insertion holes 38 formed in the inner tube component 18 and the terminal accommodating portion 62. The harnesses are inserted into the harness insertion passage 60. The terminal accommodating portion 62 accommodates the terminals of the rotating electric machine 10.

The outer tube component 22 includes a coolant inlet 64 and a coolant outlet 66. The coolant inlet 64 is disposed relatively closer to the first housing end portion 14. The coolant inlet 64 is connected to one end of the circulation passage for the coolant described above. The coolant inlet 64 communicates with the groove 54. The coolant outlet 66 is disposed relatively closer to the second housing end portion 16. The coolant outlet 66 is connected to the other end of the circulation passage for the coolant described above. The coolant outlet 66 communicates with the groove 52.

The inner peripheral surface 50is of the small-diameter tube portion 50 of the outer tube component 22 is fitted to the partial outer peripheral surface 28os-2 of the inner tube component 18. Within the inner peripheral surface 49is of the large-diameter tube portion 49 of the outer tube component 22, a portion between the groove 52 and the groove 54 faces the outer peripheral surface 20os of the cooler 20. The inner peripheral surface 49is of the large-diameter tube portion 49 of the outer tube component 22 and the outer peripheral surface 20os of the cooler 20 are separated from each other. Specifically, as shown in FIG. 3, the gap G is formed over the entire circumference between the inner peripheral surface 49is of the large-diameter tube portion 49 of the outer tube component 22 and the outer peripheral surface 20os of the cooler 20. The dimension of the gap G in the radial direction of the housing 12 is set as appropriate.

On the other hand, as shown in FIG. 2, within the inner peripheral surface 49is of the large-diameter tube portion 49 of the outer tube component 22, a portion closer to the second housing end portion 16 than the groove 52 is in close contact with the outer peripheral surface 26os of the large-diameter tube portion 26 of the inner tube component 18. The outer tube flange 56 provided with the outer tube sealing surface 56ss and the inner tube flange 32 provided with the inner tube sealing surface 32ss are fastened by fastening members such as bolts as described later.

### [2-4. Passages for Coolant Inside Housing 12]

A coolant supply passage 68 is formed along the circumferential direction of the housing 12 by the wall surface of the groove 54 of the outer tube component 22 and the partial outer peripheral surface 28os-2 of the inner tube component 18. The shape of the coolant supply passage 68 is an annular shape centered on the axis A. The coolant supply passage 68 is located at the inflow end 46 of the coolant passage 44. That is, the coolant supply passage 68 is disposed at the first end portion 20a of the cooler 20. The coolant supply passage 68 communicates with the coolant inlet 64. Consequently, the coolant passage 44 of the cooler 20 communicates with the coolant inlet 64 via the coolant supply passage 68.

The coolant discharge passage 70 is formed along the circumferential direction of the housing 12 by the wall surface of the groove 52 of the outer tube component 22, the partial outer peripheral surface 28os-1 of the inner tube component 18, and the stepped surface 30 of the inner tube component 18. The shape of the coolant discharge passage 70 is an annular shape centered on the axis A. The coolant discharge passage 70 is located at the outflow end 48 of the coolant passage 44. That is, the coolant discharge passage 70 is disposed at the second end portion 20b of the cooler 20. The coolant discharge passage 70 communicates with the coolant outlet 66. Consequently, the coolant passage 44 of the cooler 20 communicates with the coolant outlet 66 via the coolant discharge passage 70.

The passages for the coolant (the coolant supply passage 68, the coolant passage 44 of the cooler 20, and the coolant discharge passage 70) formed inside the housing 12 are sealed by the O-ring 34 and the O-ring 36.

### [3. Method for Manufacturing Housing 12]

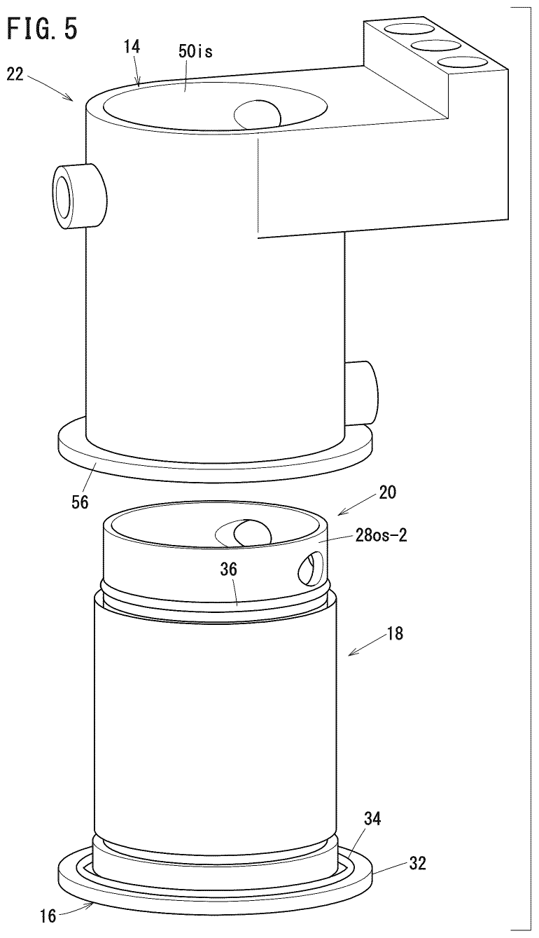

FIG. 4 is a perspective view of the inner tube component 18 and the cooler 20. FIG. 5 is a perspective view of the inner tube component 18, the cooler 20, and the outer tube component 22. The housing 12 is manufactured generally through the following processes. First, each component is formed. Specifically, the inner tube component 18 is formed by forging. The cooler 20 is formed by the AM method. The outer tube component 22 is formed by casting.

As shown in FIG. 4, the thermal grease 72 is applied to the partial outer peripheral surface 28os-1 of the inner tube component 18. The inner peripheral surface 20is of the cooler 20 is shrink-fitted to the partial outer peripheral surface 28os-1 of the inner tube component 18 to which the thermal grease 72 is applied. The O-ring 34 is mounted on the inner tube sealing surface 32ss of the inner tube component 18. The O-ring 36 is mounted on the partial outer peripheral surface 280s-2 of the inner tube component 18.

As shown in FIG. 5, the inner tube component 18 and the cooler 20 that have been integrated are inserted into the outer tube component 22. The inner peripheral surface 50is of the small-diameter tube portion 50 of the outer tube component 22 is shrink-fitted to the partial outer peripheral surface 28os-2 of the inner tube component 18. The outer tube flange 56 is superposed on the inner tube flange 32.

A lid member (not shown) closes an opening formed in the first housing end portion 14 of the housing 12. The outer tube flange 56 and the inner tube flange 32 are superposed on each other. Further, the outer tube flange 56 and the inner tube flange 32 are fastened to an attachment object (not shown) by fastening members such as bolts. As a result, an opening formed in the second housing end portion 16 of the housing 12 is closed.

### [4. Flow of Coolant in Housing 12]

The flow of the coolant in the housing 12 will be described with reference to FIG. 2. The coolant flows into the housing 12 from the coolant inlet 64. The coolant flows from the coolant inlet 64 to the coolant supply passage 68. The coolant flows into the coolant passage 44 of the cooler 20 from the inflow end 46 of the coolant passage 44 disposed in the coolant supply passage 68. The coolant flows through the coolant passage 44 from the inflow end 46 toward the outflow end 48. The coolant flows out to the coolant discharge passage 70 from the outflow end 48 disposed in the coolant discharge passage 70. The coolant flows through the coolant discharge passage 70 and flows out of the housing 12 from the coolant outlet 66.

### [5. Advantageous Effects Obtained by Housing 12 of Present Disclosure]

In the housing 12 described above, the cooler 20 that defines the coolant passage 44 of the housing 12, the outer tube component 22 that constitutes the outer peripheral portion of the housing 12, and the inner tube component 18 that constitutes the inner peripheral portion of the housing 12 are constituted by separate components. Therefore, the cooler 20, the outer tube component 22, and the inner tube component 18 can be manufactured separately. For example, the outer tube component 22 and the inner tube component 18 can be manufactured by casting or forging which gives strength, and the cooling components (the ribs 74) can be manufactured by the AM method which can form a fine and complicated shape. Therefore, it is possible to provide the housing 12 having high strength and high cooling performance. That is, according to the above disclosure, it is possible to provide the suitable housing 12.

In the housing 12 described above, the cooler 20 is disposed between the outer tube component 22 and the inner tube component 18. As a result, the cooler 20 is protected by the outer tube component 22 and the inner tube component 18.

In the housing 12 described above, the gap G is formed between the inner peripheral surface 49is of the large-diameter tube portion 49 of the outer tube component 22 and the outer peripheral surface 20os of the cooler 20. That is, the cooler 20 does not contact the outer tube component 22. Therefore, the external force acting on the outer tube component 22 is less likely to be transmitted to the cooler 20 accommodated in the outer tube component 22. Therefore, the cooler 20 is less likely to be damaged.

### [6. Internal Structure of Cooler 20]

The internal structure of the cooler 20 provided in the housing 12 will be described below. As described above, the cooler 20 includes the inner peripheral tube portion 40 and the outer peripheral tube portion 42. The coolant passage 44 is disposed between the inner peripheral tube portion 40 and the outer peripheral tube portion 42. As will be described later, the plurality of ribs 74 are disposed in the coolant passage 44. As will be described later, the plurality of ribs 74 generate turbulence in the coolant in the coolant passage 44, thereby improving the cooling performance of the cooler 20. Further, as will be described later, the plurality of ribs 74 increase the surface area of the cooler 20 that can be in contact with the coolant, thereby improving the cooling performance of the cooler 20. There are several possible modes of the arrangement and the posture of the ribs 74 in the coolant passage 44. Several modes of the cooler 20 in which the arrangements and the postures of the ribs 74 are different will be exemplified below.

### [6-1. Cooler 20 of First Example]

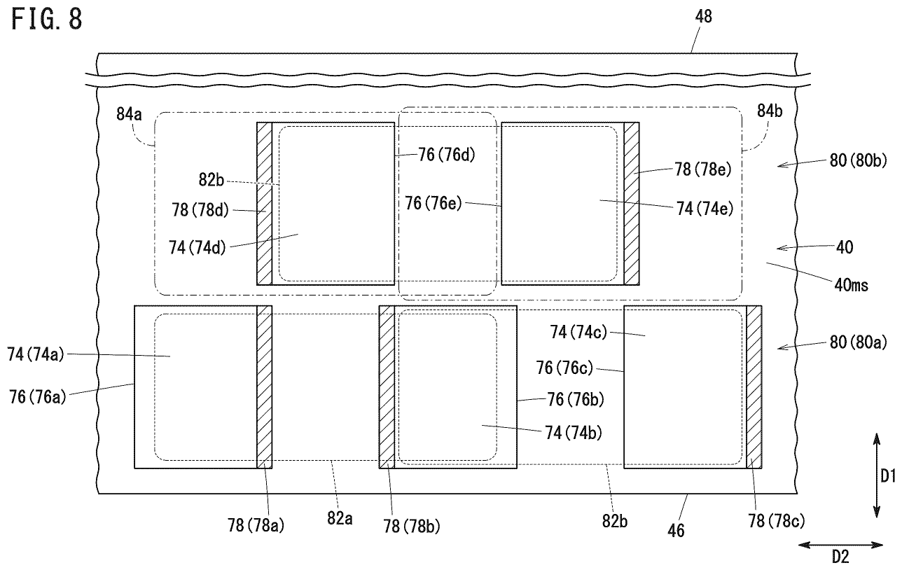

FIGS. 6 to 8 are schematic views of the inside of the cooler 20 of a first example. Hereinafter, the axial direction of the cooler 20 is defined as a first direction (D1). Further, the circumferential direction of the cooler 20 is defined as a second direction (D2). The second direction (D2) intersects the first direction (D1). Further, the radial direction of the cooler 20 is defined as a third direction (D3). It should be noted that the outer peripheral tube portion 42 is not shown in FIGS. 6 and 8. Although the inner peripheral tube portion 40 and the outer peripheral tube portion 42 are shown as flat in FIGS. 6 to 8, the inner peripheral tube portion 40 and the outer peripheral tube portion 42 are actually curved along the circumferential direction of the cooler 20.

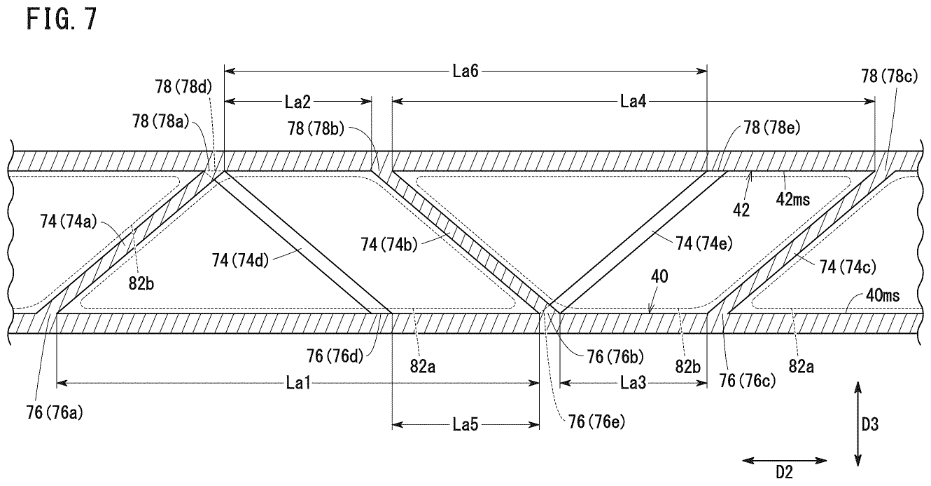

As shown in FIG. 6, the ribs 74 protrude from a main surface 40ms of the inner peripheral tube portion 40 toward the outer peripheral tube portion 42, and are connected to a main surface 42ms (see FIG. 7) of the outer peripheral tube portion 42 (see FIG. 7). In other words, the ribs 74 protrude from the main surface 42ms of the outer peripheral tube portion 42 toward the inner peripheral tube portion 40, and are connected to the main surface 40ms of the inner peripheral tube portion 40. Concerning the shape of the ribs 74, various shapes are conceivable. In the first example, the ribs 74 having a rectangular flat plate shape are illustrated. The ribs 74 are also referred to as fins.

In each of the ribs 74, a portion connected to the main surface 40ms of the inner peripheral tube portion 40 is referred to as a base end 76. In each of the ribs 74, a portion connected to the main surface 42ms of the outer peripheral tube portion 42 is referred to as a protruding end 78.

The plurality of ribs 74 are formed over the entire circumference of the cooler 20. The plurality of ribs 74 are divided into a plurality of rib groups 80. One rib group 80 includes a large number of ribs 74 arranged in the second direction (D2). The plurality of rib groups 80 are adjacent to each other in the first direction (D1). A gap is formed between two rib groups 80 adjacent to each other.

### (Rib Group 80a)

In one rib group 80, the ribs 74 in a first posture and the ribs 74 in a second posture are alternately arranged in the second direction (D2). In this instance, for the sake of simplicity, the description will be made focusing on the three ribs 74 included in a rib group 80a. The three ribs 74 illustrated in the example are referred to as a rib 74a, a rib 74b, and a rib 74c. The rib 74b is located between the rib 74a and the rib 74c. Further, the rib 74b is adjacent to the rib 74a and adjacent to the rib 74c. The ribs 74a and 74c are the ribs 74 in the first posture. The rib 74b is the rib 74 in the second posture.

As shown in FIG. 7, a partial passage 82a, which is a part of the coolant passage 44, is defined by the rib 74a, the rib 74b, the inner peripheral tube portion 40, and the outer peripheral tube portion 42. A distance La1 between a base end 76a of the rib 74a and a base end 76b of the rib 74b in the second direction (D2) is larger than a distance La2 between a protruding end 78a of the rib 74a and a protruding end 78b of the rib 74b in the second direction (D2). In the present specification, the distance between the rib 74a and the rib 74b in the second direction (D2) is defined as a width of the partial passage 82a. The width of the partial passage 82a decreases as it is away from the inner peripheral tube portion 40. Therefore, in the partial passage 82a, a difference is generated between the flow velocity of the coolant flowing near the inner peripheral tube portion 40 and the flow velocity of the coolant flowing near the outer peripheral tube portion 42.

As shown in FIG. 7, a partial passage 82b, which is a part of the coolant passage 44, is defined by the rib 74b, the rib 74c, the inner peripheral tube portion 40, and the outer peripheral tube portion 42. A distance La3 between the base end 76b of the rib 74b and a base end 76c of the rib 74c in the second direction (D2) is smaller than a distance La4 between the protruding end 78b of the rib 74b and a protruding end 78c of the rib 74c in the second direction (D2). In the present specification, the distance between the rib 74b and the rib 74c in the second direction (D2) is defined as a width of the partial passage 82b. The width of the partial passage 82b increases as it is away from the inner peripheral tube portion 40. Therefore, in the partial passage 82b, a difference is generated between the flow velocity of the coolant flowing near the inner peripheral tube portion 40 and the flow velocity of the coolant flowing near the outer peripheral tube portion 42.

As shown in FIG. 6, at the position of each rib group 80, the partial passage 82a narrower near the outer peripheral tube portion 42 than near the inner peripheral tube portion 40, and the partial passage 82b wider near the outer peripheral tube portion 42 than near the inner peripheral tube portion 40, are alternately arranged in the second direction (D2). The rib 74 is interposed between the partial passage 82a and the partial passage 82b adjacent to each other.

### (Rib Group 80b)

As shown in FIG. 6, the plurality of ribs 74 included in the rib groups 80 other than the rib group 80a are also arranged in the same manner as the plurality of ribs 74 included in the rib group 80a. For example, the plurality of ribs 74 included in a rib group 80b adjacent to the rib group 80a are also arranged in the same manner as the plurality of ribs 74 included in the rib group 80a. It should be noted that the partial passages 82a and 82b at the position of the rib group 80b are eccentric with respect to the partial passages 82a and 82b at the position of the rib group 80a. Here, the arrangement and the posture of the plurality of ribs 74 included in the two rib groups 80 will be described by taking three ribs 74 included in the rib group 80a and two ribs 74 included in the rib group 80b as an example. The two ribs 74 included in the rib group 80b are referred to as a rib 74d and a rib 74e. The rib 74d is adjacent to the rib 74e. The rib 74d is the rib 74 in the second posture. The rib 74e is the rib 74 in the first posture.

As shown in FIG. 8, a space obtained by virtually extending the partial passage 82a toward the downstream of the coolant is referred to as a first extension space 84a. A space obtained by virtually extending the partial passage 82b toward the downstream of the coolant is referred to as a second extension space 84b. At least a portion of the rib 74d is located in the first extension space 84a. At least a portion of the rib 74e is located in the second extension space 84b.

As shown in FIG. 7, a distance La5 between a base end 76d of the rib 74d and a base end 76e of the rib 74e in the second direction (D2) is different from a distance La6 between a protruding end 78d of the rib 74d and a protruding end 78e of the rib 74e in the second direction (D2).

In FIGS. 6 to 8, the entire rib 74d is located in the first extension space 84a. In FIGS. 6 to 8, the posture of the rib 74d is the same as the posture of the rib 74b. In FIGS. 6 to 8, the entire rib 74e is located in the second extension space 84b. In FIGS. 6 to 8, the posture of the rib 74e is the same as the postures of the ribs 74a and 74c. In FIGS. 6 to 8, the distance La5 is smaller than the distance La6.

It should be noted that a first portion of the rib 74d may be located in the first extension space 84a, and a second portion of the rib 74d may be located in the second extension space 84b. Further, a first portion of the rib 74e may be located in the first extension space 84a, and a second portion of the rib 74e may be located in the second extension space 84b. Further, the posture of the rib 74d may be the same as the postures of the ribs 74a and 74c, and the posture of the rib 74e may be the same as the posture of the rib 74b. In this case, the distance La5 is larger than the distance La6.

As shown in FIG. 8, the partial passage 82b at the position of the rib group 80b is arranged across the first extension space 84a and the second extension space 84b. Similarly, the partial passage 82a at the position of the rib group 80b is arranged across the first extension space 84a and the second extension space 84b.

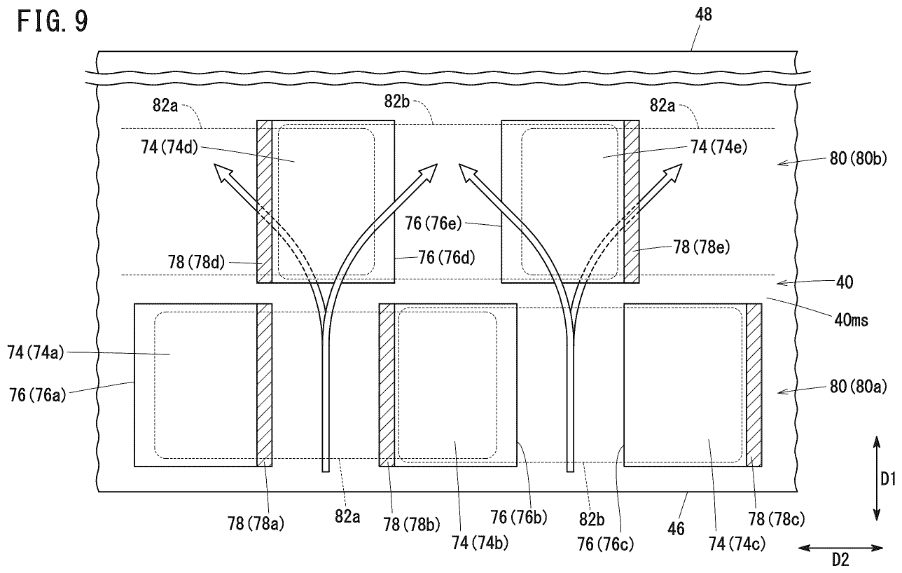

As shown in FIG. 9, the rib 74d divides the coolant flowing through the partial passage 82a at the position of the rib group 80a into two partial passages 82a and 82b at the position of the rib group 80b. The rib 74e divides the coolant flowing through the partial passage 82b at the position of the rib group 80a into two partial passages 82a and 82b at the position of the rib group 80b.

### (Specific Example of Numerical Values Regarding Ribs 74)

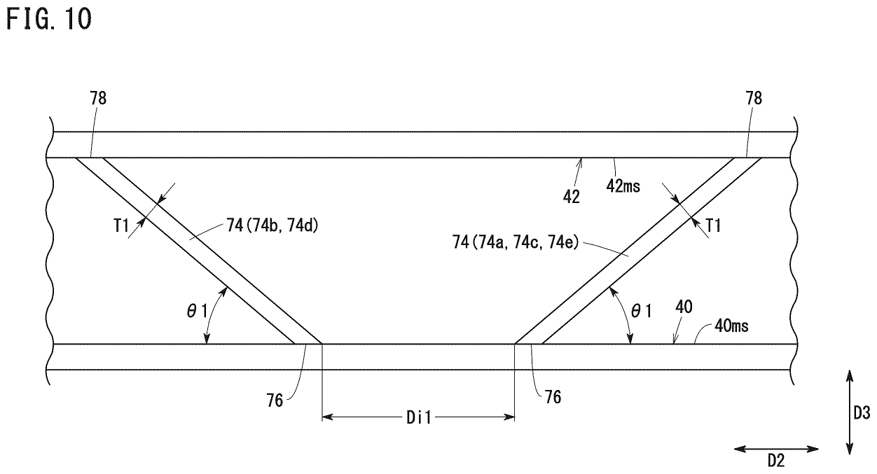

FIG. 10 is an enlarged view of a pair of ribs 74 (the ribs 74a, 74c, and 74e in the first posture, and the ribs 74b and 74d in the second posture). The ribs 74a, 74c, and 74e in the first posture are different from the ribs 74b and 74d in the second posture in the direction in which they are inclined with respect to the main surface 40ms (the direction in which they protrude from the main surface 40ms). On the other hand, an inclination angle θ1 of the ribs 74a, 74c, and 74e with respect to the main surface 40ms of the inner peripheral tube portion 40 is the same as an inclination angle θ1 of the ribs 74b and 74d with respect to the main surface 40ms of the inner peripheral tube portion 40. By setting the inclination angle θ1 of the ribs 74 to 3 degrees or more, an appropriate flow velocity difference can be generated between the coolant flowing near the inner peripheral tube portion 40 and the coolant flowing near the outer peripheral tube portion 42 in the partial passages 82a and 82b. On the other hand, when the inclination angle θ1 of the ribs 74 exceeds 45 degrees, the cooling performance of the cooler 20 is significantly reduced. From the above, it is considered that the inclination angle θ1 of the ribs 74 with respect to the main surface 40ms of the inner peripheral tube portion 40 is preferably about 3 to 45 degrees.

From the viewpoint of increasing the surface area of the cooler 20 that can be in contact with the coolant, a thickness T1 of the ribs 74 is preferably thin. As the thickness T1 of the ribs 74 decreases, the number of the ribs 74 that can be formed in the cooler 20 increases. As the number of the ribs 74 increases, the surface area of the cooler 20 that can be in contact with the coolant increases. Therefore, the cooling performance of the cooler 20 is improved. When the thickness T1 of the ribs 74 exceeds 5 mm, the cooling performance of the cooler 20 is significantly reduced. According to the current AM method, the minimum formable thickness is about 0.2 mm. From the above, it is considered that the thickness T1 of the ribs 74 is preferably 0.2 mm or more and 5 mm or less.

From the viewpoint of increasing the surface area of the cooler 20 that can be in contact with the coolant, a separation distance Di1 between a pair of adjacent ribs 74 is preferably small. The separation distance Di1 is the smaller of the distances between the base ends 76 and between the protruding ends 78 of the pair of ribs 74. According to the current AM method, the minimum formable clearance is about 0.1 mm. Therefore, the lower limit of the separation distance Di1 between the pair of adjacent ribs 74 is about 0.1 mm.

### (Advantageous Effects Obtained by Cooler 20 of First Example)

According to the first example, a flow velocity difference can be generated in the coolant in one passage (the partial passage 82a, 82b) sandwiched between a pair of ribs 74 adjacent to each other in the second direction (D2). Specifically, in one partial passage 82a, 82b, the flow velocity of the coolant can be changed for each position in the third direction (D3). In addition, in one rib group 80, the flow velocity of the coolant can be changed also between the partial passage 82a and the partial passage 82b adjacent to each other. By generating a flow velocity difference in the coolant flowing in the same direction, turbulence of the coolant is likely to be generated. When the turbulence is generated, the coolant is stirred. Then, unevenness of the temperature of the coolant in the coolant passage 44 is reduced. As a result, the cooling performance of the cooler 20 is improved. That is, according to the first example, it is possible to provide the suitable cooler 20.

According to the first example, the partial passage 82a and the partial passage 82b are alternately arranged in the second direction (D2). This complicates the flow of the coolant, and the turbulence of the coolant is more likely to occur. Therefore, the coolant is stirred, and the unevenness of the temperature of the coolant in the coolant passage 44 is reduced.

According to the first example, the coolant flowing through the partial passage 82a at the position of the rib group 80a is divided into the two partial passages 82a and 82b by the rib 74d at the position of the rib group 80b. Similarly, the coolant flowing through the partial passage 82b at the position of the rib group 80a is divided into the two partial passages 82a and 82b by the rib 74e at the position of the rib group 80b. This complicates the flow of the coolant, and the turbulence of the coolant is more likely to occur. Therefore, the coolant is stirred, and the unevenness of the temperature of the coolant in the coolant passage 44 is reduced.

### [6-2. Cooler 20 of Second Example]

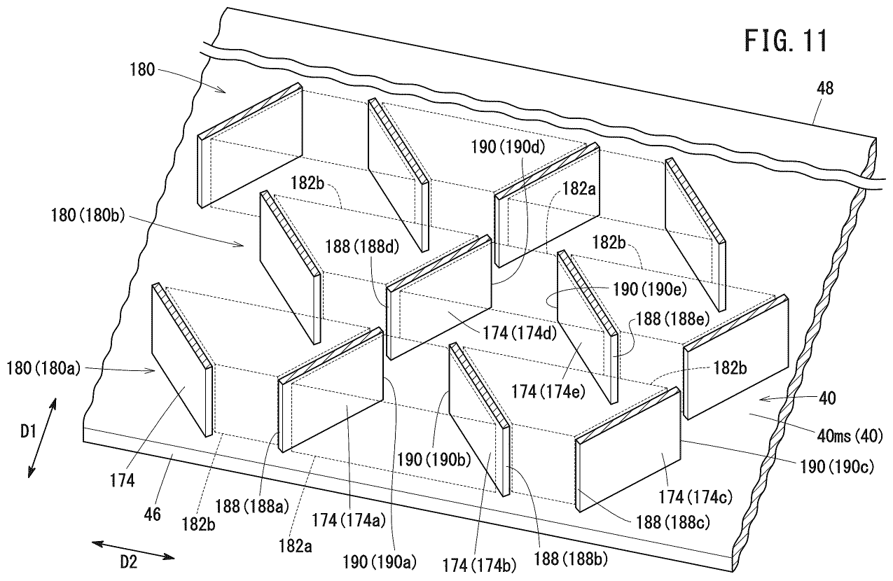

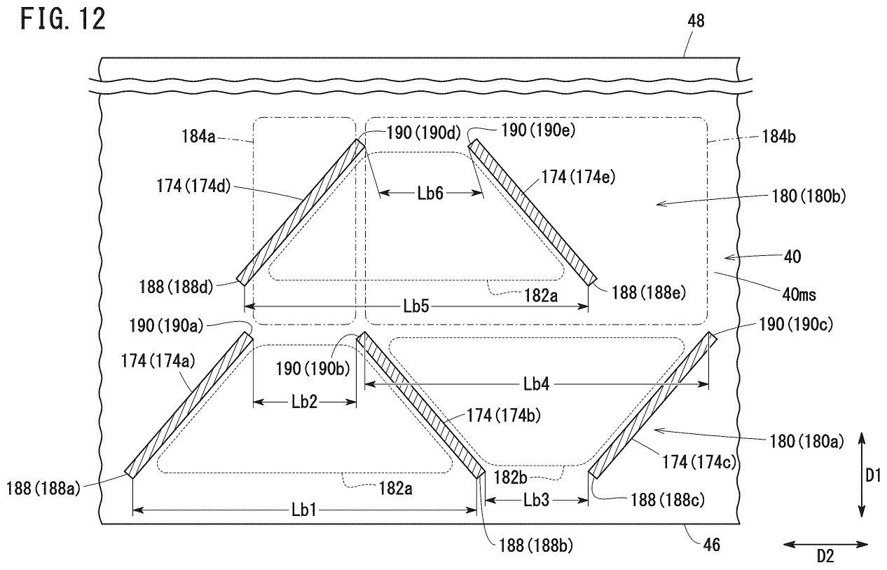

FIGS. 11 and 12 are schematic views of the inside of the cooler 20 of a second example. The following description will be focused on the difference between the cooler 20 of the second example and the cooler 20 of the first example. The cooler 20 of the first example and the cooler 20 of the second example are different from each other in the posture of ribs 174.

A portion of each rib 174 that is disposed closer to the inflow end 46 of the coolant passage 44 is referred to as an upstream side end portion 188. A portion of each rib 174 that is disposed closer to the outflow end 48 of the coolant passage 44 is referred to as a downstream side end portion 190.

### (Rib Group 180a)

As shown in FIG. 11, in one rib group 180, the ribs 174 in a third posture and the ribs 174 in a fourth posture are alternately arranged in the second direction (D2). In this instance, for the sake of simplicity of description, the arrangement and the posture of the plurality of ribs 174 included in one rib group 180 will be described by taking three ribs 174 included in the rib group 180a as an example. The three ribs 174 illustrated in the example are referred to as a rib 174a, a rib 174b, and a rib 174c. The rib 174b is located between the rib 174a and the rib 174c. Further, the rib 174b is adjacent to the rib 174a and adjacent to the rib 174c. The ribs 174a and 174c are the ribs 174 in the third posture. The rib 174b is the rib 174 in the fourth posture.

As shown in FIG. 12, a partial passage 182a, which is a part of the coolant passage 44, is defined by the rib 174a, the rib 174b, the inner peripheral tube portion 40 (FIG. 2 or the like), and the outer peripheral tube portion 42 (FIG. 2 or the like). A distance Lb1 between an upstream side end portion 188a of the rib 174a and an upstream side end portion 188b of the rib 174b in the second direction (D2) is larger than a distance Lb2 between a downstream side end portion 190a of the rib 174a and a downstream side end portion 190b of the rib 174b in the second direction (D2). The width of the partial passage 182a decreases as it is away from the inflow end 46. Therefore, in the partial passage 182a, a difference is generated between the flow velocity of the coolant flowing near the inflow end 46 and the flow velocity of the coolant flowing near the outflow end 48.

As shown in FIG. 12, a partial passage 182b, which is a part of the coolant passage 44, is defined by the rib 174b, the rib 174c, the inner peripheral tube portion 40, and the outer peripheral tube portion 42. A distance Lb3 between the upstream side end portion 188b of the rib 174b and an upstream side end portion 188c of the rib 174c in the second direction (D2) is smaller than a distance Lb4 between the downstream side end portion 190b of the rib 174b and a downstream side end portion 190c of the rib 174c in the second direction (D2). The width of the partial passage 182b increases as it is away from the inflow end 46. Therefore, in the partial passage 182b, a difference is generated between the flow velocity of the coolant flowing near the inflow end 46 and the flow velocity of the coolant flowing near the outflow end 48.

As shown in FIG. 11, at the position of each rib group 180, the partial passage 182a wider near the inflow end 46 than near the outflow end 48, and the partial passage 182b narrower near the inflow end 46 than near the outflow end 48, are alternately arranged in the second direction (D2). The rib 174 is interposed between the partial passage 182a and the partial passage 182b adjacent to each other.

### (Rib Group 180b)

As shown in FIG. 11, the plurality of ribs 174 included in the rib groups 180 other than the rib group 180a are also arranged in the same manner as the plurality of ribs 174 included in the rib group 180a. For example, the plurality of ribs 174 included in a rib group 180b adjacent to the rib group 180a are also arranged in the same manner as the plurality of ribs 174 included in the rib group 180a. It should be noted that the partial passages 182a and 182b at the position of the rib group 180b are eccentric with respect to the partial passages 182a and 182b at the position of the rib group 180a. Here, the arrangement and the posture of the plurality of ribs 174 included in the two rib groups 180 will be described by taking three ribs 174 included in the rib group 180a and two ribs 174 included in the rib group 180b as an example. The two ribs 174 included in the rib group 180b are referred to as a rib 174d and a rib 174e. The rib 174d is adjacent to the rib 174e. The rib 174d is the rib 174 in the third posture. The rib 174e is the rib 174 in the fourth posture.

As shown in FIG. 12, a space obtained by virtually extending the partial passage 182a toward the downstream of the coolant is referred to as a first extension space 184a. A space obtained by virtually extending the partial passage 182b toward the downstream of the coolant is referred to as a second extension space 184b. At least a portion of the rib 174d is located in the first extension space 184a. At least a portion of the rib 174e is located in the second extension space 184b. A distance Lb5 between an upstream side end portion 188d of the rib 174d and an upstream side end portion 188e of the rib 174e in the second direction (D2) is different from a distance Lb6 between a downstream side end portion 190d of the rib 174d and a downstream side end portion 190e of the rib 174e in the second direction (D2).

It should be noted that at least a portion of the rib 174d may be located in the second extension space 184b. Further, at least a portion of the rib 174e may be located in the first extension space 184a.

As shown in FIG. 12, the partial passage 182a at the position of the rib group 180b is arranged across the first extension space 184a and the second extension space 184b. Similarly, the partial passage 182b at the position of the rib group 180b is arranged across the first extension space 184a and the second extension space 184b.

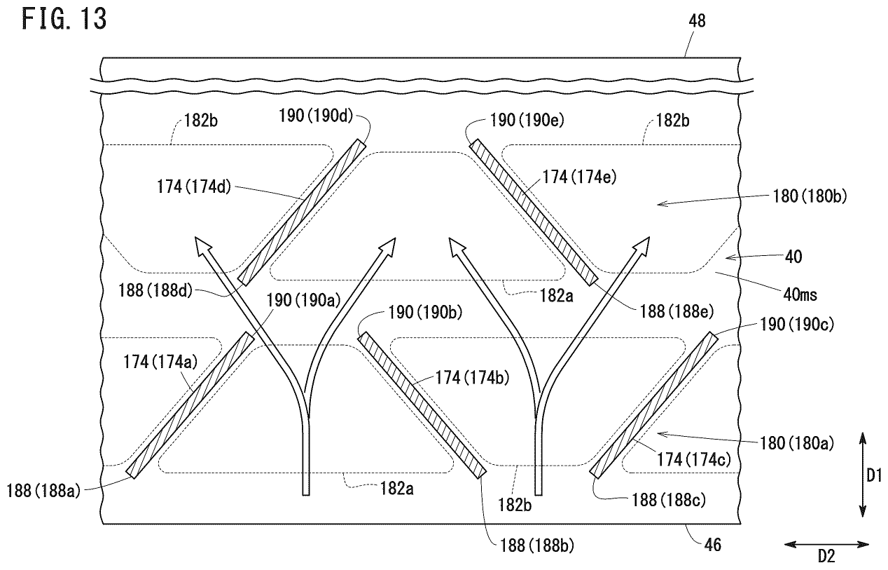

As shown in FIG. 13, the rib 174d divides the coolant flowing through the partial passage 182a at the position of the rib group 180a into two partial passages 182a and 182b at the position of the rib group 180b. The rib 174e divides the coolant flowing through the partial passage 182b at the position of the rib group 180a into two partial passages 182a and 182b at the position of the rib group 180b.

### (Specific Example of Numerical Values Regarding Ribs 174)

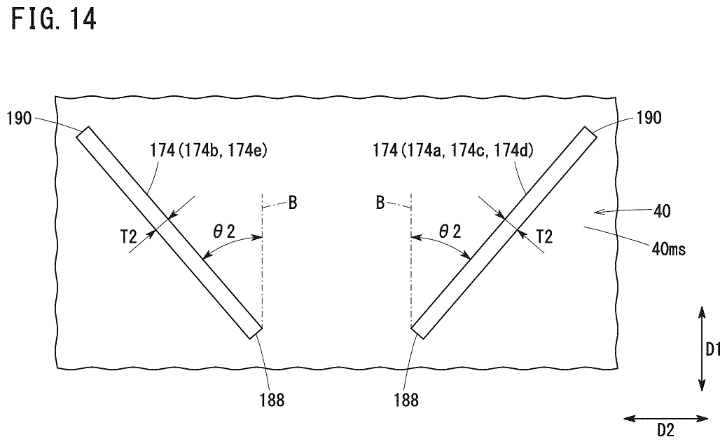

FIG. 14 is an enlarged view of the pair of ribs 174 (the ribs 174a, 174c, and 174d in the third posture, and the ribs 174b and 174e in the fourth posture). The ribs 174a, 174c, and 174d in the third posture are different from the ribs 174b and 174e in the fourth posture in the direction in which they extend from the inflow end 46 toward the outflow end 48. On the other hand, an inclination angle θ2 of the ribs 174a, 174c, and 174d with respect to an imaginary line B that is parallel to the axis A is the same as an inclination angle θ2 of the ribs 174b and 174e with respect to the imaginary line B. That is, the inclination angles θ2 of the ribs 174a to 174e with respect to the first direction (D1) are the same. By setting the inclination angle θ2 of the ribs 174 to 3 degrees or more, an appropriate flow velocity difference can be generated between the coolant flowing near the inflow end 46 and the coolant flowing near the outflow end 48 in the partial passages 182a and 182b. Furthermore, the flow velocity of the coolant can be made moderate. On the other hand, when the inclination angle θ2 of the ribs 174 exceeds 45 degrees, separation of the coolant from the ribs 174 occurs, and the cooling performance of the cooler 20 is reduced. From the above, it is considered that the inclination angle θ2 of the ribs 174 with respect to the first direction (D1) is preferably about 3 to 45 degrees.

From the viewpoint of increasing the surface area of the cooler 20 that can be in contact with the coolant, a thickness T2 of the ribs 174 is preferably thin. As the thickness T2 of the ribs 174 decreases, the number of the ribs 174 that can be formed in the cooler 20 increases. As the number of the ribs 174 increases, the surface area of the cooler 20 that can be in contact with the coolant increases. Therefore, the cooling performance of the cooler 20 is improved. When the thickness T2 of the ribs 174 exceeds 5 mm, the cooling performance of the cooler 20 is significantly reduced. According to the current AM method, the minimum formable thickness is about 0.2 mm. From the above, it is considered that the thickness T2 of the ribs 174 is preferably 0.2 mm or more and 5 mm or less.

### (Advantageous Effects Obtained by Cooler 20 of Second Example)

According to the second example, a flow velocity difference can be generated in the coolant in one passage (the partial passage 182a, 182b) sandwiched between a pair of ribs 174 adjacent to each other in the second direction (D2). Specifically, in one partial passage 182a, 182b, the flow velocity of the coolant can be changed for each position in the first direction (D1). In addition, in one rib group 180, the flow velocity of the coolant can be changed also between the partial passage 182a and the partial passage 182b adjacent to each other. By generating a flow velocity difference in the coolant flowing in the same direction, turbulence of the coolant is likely to be generated. When the turbulence is generated, the coolant is stirred. Then, unevenness of the temperature of the coolant in the coolant passage 44 is reduced. As a result, the cooling performance of the cooler 20 is improved. That is, according to the second example, it is possible to provide the suitable cooler 20.

According to the second example, the partial passage 182a and the partial passage 182b are alternately arranged in the second direction (D2). This complicates the flow of the coolant, and the turbulence of the coolant is more likely to occur. Therefore, the coolant is stirred, and the unevenness of the temperature of the coolant in the coolant passage 44 is reduced.

According to the second example, the coolant flowing through the partial passage 182a at the position of the rib group 180a is divided into the two partial passages 182a and 182b by the rib 174d at the position of the rib group 180b. Similarly, the coolant flowing through the partial passage 182b at the position of the rib group 180a is divided into the two partial passages 182a and 182b by the rib 174e at the position of the rib group 180b. This complicates the flow of the coolant, and the turbulence of the coolant is more likely to occur. Therefore, the coolant is stirred, and the unevenness of the temperature of the coolant in the coolant passage 44 is reduced.

According to the second example, each rib 174 is inclined with respect to the imaginary line B that is parallel to the axis A of the housing 12. Consequently, each rib 174 functions as an obstacle to the coolant. Then, the flow of the coolant becomes complicated, and the coolant flows at a moderate flow velocity inside the coolant passage 44. Therefore, the amount of heat absorbed by the coolant can be improved.

### [7. Modification]

The cooler 20 of the first example and the cooler 20 of the second example include the inner peripheral tube portion 40, the outer peripheral tube portion 42, and the plurality of ribs 74, 174. However, the cooler 20 may not include the outer peripheral tube portion 42. In this case, the coolant flows between the inner peripheral tube portion 40 and the inner peripheral surface 49is of the large-diameter tube portion 49. The gap G is formed between the inner peripheral surface 49is of the large-diameter tube portion 49 of the outer tube component 22, and the protruding end 78 of each rib 74 or the protruding end (no reference numeral) of each rib 174.

The cooler 20 of the first example and the cooler 20 of the second example may be combined. Specifically, the ribs 74 and 174 provided in the cooler 20 may be inclined with respect to the main surface 40ms of the inner peripheral tube portion 40 and inclined with respect to the imaginary line B that is parallel to the axis A.

In the description of the first example and the description of the second example, the rectangular flat plate shaped ribs 74 and 174 are illustrated. However, the shapes of the ribs 74 and 174 are not limited thereto. For example, the ribs 74 and 174 may be curved in either direction. Further, the ribs 74 and 174 may also be corrugated. In addition, the thickness of the ribs 74 and 174 near the inner peripheral tube portion 40 may be different from the thickness of the ribs 74 and 174 near the outer peripheral tube portion 42. Further, the thickness of the ribs 74 and 174 near the inflow end 46 may be different from the thickness of the ribs 74 and 174 near the outflow end 48.

### [8. Supplementary Notes]

The following supplementary notes are further disclosed in relation to the above-described disclosure.

### Supplementary Note 1

The housing (12) of the present disclosure includes: the inner tube component (18) having a tubular shape and configured to accommodate a heating element in the interior of the inner tube component; the cooler (20) having a tubular shape and configured to define the coolant passage (44) for causing the coolant to flow along the outer peripheral surface (26os, 28os) of the inner tube component; and the outer tube component (22) having a tubular shape and configured to accommodate the inner tube component and the cooler in the interior of the outer tube component.

In the housing having the above-described configuration, the cooler that defines the coolant passage of the housing, the outer tube component that constitutes the outer peripheral portion of the housing, and the inner tube component that constitutes the inner peripheral portion of the housing are separate components. Therefore, the cooler, the outer tube component, and the inner tube component can be manufactured separately. For example, the outer tube component and the inner tube component can be manufactured by casting or forging which gives strength, and the cooling components (the ribs) can be manufactured by the AM method which can form a fine and complicated shape. Therefore, it is possible to provide a housing having high strength and high cooling performance. That is, according to the above configuration, it is possible to provide a suitable housing.

### Supplementary Note 2

In the housing according to supplementary note 1, the cooler and the outer tube component may be separated from each other.

In the above configuration, the cooler does not contact the outer tube component. Therefore, the external force acting on the outer tube component is less likely to be transmitted to the cooler accommodated in the outer tube component. Therefore, according to the above configuration, the cooler is less likely to be damaged.

### Supplementary Note 3

In the housing according to supplementary note 2, the outer peripheral surface of the inner tube component may include the first partial outer peripheral surface (28os-1) disposed on one side in the axial direction of the inner tube component, and the second partial outer peripheral surface (28os-2) disposed on the other side in the axial direction, the first partial outer peripheral surface of the inner tube component and the inner peripheral surface (20is) of the cooler may be fitted to each other, and the second partial outer peripheral surface of the inner tube component and a part of the inner peripheral surface (50is) of the outer tube component may be fitted to each other.

### Supplementary Note 4

In the housing according to supplementary note 1, the inner tube component may include the inner tube flange (32) formed on one side in the axial direction of the inner tube component and extending in the radial direction of the inner tube component, the outer tube component may include the outer tube flange (56) formed on the one side in the axial direction and extending in the radial direction, and the casing (58) formed on the other side in the axial direction, the inner tube flange and the outer tube flange may be fastened by a fastening member, and the casing may be configured to accommodate the terminals provided in electrical components (a rotor and a stator) serving as the heating element.

### Supplementary Note 5

In the housing according to supplementary note 1, the cooler may include the rib (74, 174) configured to generate turbulence in the coolant in the coolant passage.

According to the above configuration, the cooling capacity of the cooler can be improved.

### Supplementary Note 6

In the housing according to supplementary note 1, the cooler may include the inner peripheral tube portion (40) configured to form the inner peripheral surface of the cooler, and the outer peripheral tube portion (42) configured to form the outer peripheral surface (200s) of the cooler, and the coolant passage may be formed between the inner peripheral tube portion and the outer peripheral tube portion.

### Supplementary Note 7

In the housing according to supplementary note 1, the outer tube component may include the coolant inlet (64) formed on one side in the axial direction of the outer tube component and connected to the coolant passage, and the coolant outlet (66) formed on the other side in the axial direction and connected to the coolant passage, and the coolant passage may cause the coolant to flow in a direction lying along the axial direction.

### Supplementary Note 8

The rotating electric machine (10) of the present disclosure includes the housing according to any one of supplementary notes 1 to 7.

The present invention is not limited to the above disclosure, and various modifications are possible without departing from the essence and gist of the present invention.

1. A housing comprising:
an inner tube component having a tubular shape and configured to accommodate a heating element in an interior of the inner tube component;
a cooler having a tubular shape and configured to define a coolant passage for causing a coolant to flow along an outer peripheral surface of the inner tube component; and
an outer tube component having a tubular shape and configured to accommodate the inner tube component and the cooler in an interior of the outer tube component.

2. The housing according to claim 1, wherein
the cooler and the outer tube component are separated from each other.

3. The housing according to claim 2, wherein
the outer peripheral surface of the inner tube component includes a first partial outer peripheral surface disposed on one side in an axial direction of the inner tube component, and a second partial outer peripheral surface disposed on another side in the axial direction,
the first partial outer peripheral surface of the inner tube component and an inner peripheral surface of the cooler are fitted to each other, and
the second partial outer peripheral surface of the inner tube component and a part of an inner peripheral surface of the outer tube component are fitted to each other.

4. The housing according to claim 1, wherein
the inner tube component includes an inner tube flange formed on one side in an axial direction of the inner tube component and extending in a radial direction of the inner tube component,
the outer tube component includes an outer tube flange formed on the one side in the axial direction and extending in the radial direction, and a casing formed on another side in the axial direction,
the inner tube flange and the outer tube flange are fastened by a fastening member, and
the casing is configured to accommodate a terminal provided in an electrical component serving as the heating element.

5. The housing according to claim 1, wherein
the cooler includes a rib configured to generate turbulence in the coolant in the coolant passage.

6. The housing according to claim 1, wherein
the cooler includes an inner peripheral tube portion configured to form an inner peripheral surface of the cooler, and an outer peripheral tube portion configured to form an outer peripheral surface of the cooler, and
the coolant passage is formed between the inner peripheral tube portion and the outer peripheral tube portion.

7. The housing according to claim 1, wherein
the outer tube component includes a coolant inlet formed on one side in an axial direction of the outer tube component and connected to the coolant passage, and a coolant outlet formed on another side in the axial direction and connected to the coolant passage, and
the coolant passage causes the coolant to flow in a direction lying along the axial direction.

8. A rotating electric machine comprising the housing according to claim 1.
